(19) United States
(12) Patent Application Publication
(10) Pub. No.: US 2014/0358815 A1
(43) Pub. Date: Dec. 4, 2014

(54) Virtual Plan Room

(71) Applicant: Ron Bourque, Waltham, MA (US)

(72) Inventor: Ron Bourque, Waltham, MA (US)

(21) Appl. No.: 13/905,440

(22) Filed: May 30, 2013

(51) Int. Cl. G06Q 10/10; G06F 17/30

(52) U.S. Cl. CPC G06Q 10/10; G06F 17/30244; G06F 17/30342
USPC 705/342

(57) ABSTRACT

A modular, web-based document retrieval system is provided. The system allows for immediate access to all existing building plan drawings and documents for a site. The document retrieval system herein provides an efficient, organized and substantially automated solution for storing, tracking and accessing facility construction documents.

### BACKGROUND OF THE INVENTION

1. Field of the Invention

The present invention relates generally to a system for electronic document storage and access. More particularly the present invention relates to a virtual plan room system that allows conversion of hard copy drawings into electronic versions, as well as providing searchable computerized access to the documents.

2. Description of Related Art

Building and site drawings are extremely important for record keeping, tracking building developments, planning, and the like. Particularly with older buildings, there can be a tremendous amount of these drawings tracking the site over time. These drawings are often stored on paper in plan rooms, and take up space, and become very messy, disorganized and difficult to track. As such, searching for, referencing, and putting back drawings can be a very time consuming and difficult process.

Therefore, what is needed is a system that may effectively store and track electronic copies of plan room drawings in an orderly and organized fashion, allowing for easy location and retrieval of the drawings and related documents.

### SUMMARY OF THE INVENTION

The subject matter of this application may involve, in some cases, interrelated products, alternative solutions to a particular problem, and/or a plurality of different uses of a single system or article.

In one aspect, a method of scanning, organizing and providing access to building plan drawings is provided. The method begins with identifying the paper building plan drawings to be input into the system. These paper drawings are scanned using a computerized scanner, and the scans are saved to a computer storage unit. Information relating to the scanned building plan drawings is then input into a computerized spreadsheet. The information input comprises at least: building name, drawing floor level, and drawing discipline. A computerized database population module is then used to populate a database based on information in the spreadsheet, and the scanned drawings. As new or updated drawings are created, the database population module may further repopulate the database with additional information. This database is made available to an authorized user or users, allowing them to access the drawings through the database. The database may be organizable and searchable based on the inputted information.

In another aspect, a method of accessing a building drawing of a set of site drawings using a computer is provided. The method begins with a user logging into a computer accessible service providing the drawings. Once logged in, the user may identify and select a building site corresponding to the site of the desired drawings. Next, the particular building may be identified and selected. After this, the floor of the building may be selected and identified. Finally, drawing discipline (architectural, landscape, etc) may be identified and selected for the floor of the building. At this point the system may provide a list of all appropriate drawings corresponding to the selected criteria. The desired drawings may then be selected and acquired.

In yet another aspect, a computerized system for scanning, organizing, and providing access to building plan drawings is provided. The system comprises a computer in communication with an electronic storage unit. The storage unit having a quantity of scanned building plan drawings, and a spreadsheet containing information relating to each building plan drawing. The system further has a computerized data population module in communication with the computer. The data population module is configured to automatically populate a database with contents of the spreadsheet and building plan drawings. The computerized data population module is also capable of supplementing the database with additional information provided by a second spreadsheet or an updated spreadsheet as drawings change, are added, or are updated. The database is configured to be remotely accessible to a plurality of computerized users. The computerized users are in turn capable of sorting the building plan drawings based on the information related to the building plan drawings. Further, the users may be capable of accessing and receiving the building plan drawings.

### BRIEF DESCRIPTION OF THE DRAWINGS

FIG. 1 provides a flow chart of steps involved in an embodiment of system set up.

FIG. 2 provides another embodiment of a flow chart of the system in operation.

FIG. 3 provides a detail flow chart of populating the database using the computerized module.

FIG. 4 provides a flow chart of details of interface options for importing paper documents into the system.

FIG. 5 provides a flow chart of an embodiment of a client side interface provided by the system.

FIG. 6 provides a data flow chart of the components of an embodiment of the system.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention comprises a modular, web-based document retrieval system that allows for immediate access to all existing facility construction documents. The document retrieval system herein provides an efficient, organized and substantially automated solution for storing, tracking and accessing facility construction documents.

The system contemplated herein allows for drawings of any number of sites for any number of clients. Initially, site drawings may be converted from paper versions to electronic versions. In this process, the drawings and documents may be scanned to produce electronic copies. In one embodiment, the scanning may be performed by an outside scanning service. In another embodiment, the scanning may be performed by the owners of the documents. In still another embodiment, the scanning may be performed by the system providers.

Once scanned, the documents may be processed. In one embodiment, this processing may be performed manually by entering the document information into a spreadsheet or database. In another embodiment, a computerized processing module may be used to automatically process the scanned drawings, spreadsheet relating to the drawings, or document related information into either a spreadsheet or a database.

In one embodiment, a spreadsheet file such as a Microsoft® Excel® spreadsheet containing information relating to the drawings may be manually created. This spreadsheet may contain information relating to the drawings including, but not limited to: building name, floor level, project name, drawing discipline (architectural, engineering, landscape, etc.), project number, drawing title, sheet number, date, reference number, document name, and the like. In one embodiment, each drawing will have at least a building name, floor level and drawing discipline associated with it.

In another embodiment, a spreadsheet file may be automatically created from the scanned drawings. This automatic creation may be performed by a computer and may utilized optical character recognition (OCR) to identify language on the scanned documents. This language may then be processed and identified by the computer as information relating to the drawings as noted above. One identified, the OCR identified language may be inputted into the proper spreadsheet field using the computer.

In yet another embodiment, a database file may be automatically created from the scanned drawings. This automatic creation may be performed by a computer and may utilized optical character recognition (OCR) to identify language on the scanned documents. This language may then be processed and identified by the computer as information relating to the drawings as noted above. One identified, the OCR identified language may be inputted into the proper database field using the computer. The computer may further organize the drawings and drawing information into categories and subcategories as discussed below.

In a particular embodiment, a computerized guidance module may be implemented to instruct a scanner user to identify particular places of the document that correspond to particular information. Further still, a pen style scanner may be used to scan in appropriate areas to aid in filling the data fields corresponding to required fields. For example the computerized guidance module may prompt a user to identify building level, and the user may scan or identify the area on the drawing where that information is provided. The module may then use OCR or similar technology to convert the identified information in to text, and input that text into the database or spreadsheet.

An error check module may be performed using a computer to identify missing, or corrupted entries of the spreadsheet or database. Depending on embodiment, certain information may be allowed to be omitted, and the error check module may flag it as missing but not essential. For required information, the error check module may identify missing information and note that it is required. For example, in an embodiment requiring a building name, if a building name is missing the error check module will flag it and require building name input. This input likely will be performed manually, though computerized error correction is possible.

In a further embodiment, the error check module may identify corrupted or improper entries into a field. For example, for a field requiring the floor level, a numerical value would be expected. If a text such as “architectural” were input into this field, the error check module may identify that it is an improper entry and flag it for correction.

The error check module may provide a text or other document output file, or may provide in-line error identification within the database or spreadsheet.

In an embodiment wherein the drawing information is entered into a spreadsheet file, a computerized module may be requited to input the spreadsheet information into a database, the database being accessible to an online interface such as a web browser. The computerized module for generating and filling the database may be configured to allow an initial generation of the database, as well as supplementing the database with new or updated plan drawings. The module may operate by linking the drawing with the information associated with it in the spreadsheet. As such, the database will allow users of the database to identify documents based on any of the information associated with it. For example, a user may identify building, level, and discipline, and find the drawing or drawings desired, as detailed below.

The module may further be configured to supplement the database upon the creation and scanning of new or updated drawings. In this embodiment of operation, the module may create new informational fields corresponding to the information of the new drawings, without disturbing the existing database information.

In a further embodiment, the database may be manually generated based on information from the drawings and/or information from the spreadsheet.

The error check module may further be used to confirm proper data entry into the database, and may operate as discussed above after the computerized module has filled in the database.

Once the database is populated with the appropriate drawing information, it may be organized and categorized. At a top level, drawings are organized by site. For example, a university may have more than one site, such as a main campus and satellite campus. Within the site are a number of buildings, each building being a subcategory of the site. Within each building are levels, such as a basement, first floor, and second floor, these levels are a subcategory of the building. Once level is selected, multiple drawings may be presented. These drawings may be further separated by drawing discipline, date, project, revision, date, and the like.

In some embodiments, templates may be used to aid in formatting the database and/or spreadsheet.

Once the above processing is completed, the owner of the drawings now has a categorized and computerized database of all site drawings. The database may be stored on a server which provides electronic access to authorized users. As will be discussed below, the system contemplated herein may further make this database of drawings remotely accessible allowing the drawings owner, and employees and agents, to access the drawings.

The online interface allowing users access to the drawings of the database may be implemented in any way that allows computerized remote access. For example, the online interface may be a web page, mobile app, computer application, or integrated interface of a device.

In one embodiment, a web interface may be provided. A user may sign up and identify what set of drawings they require access too. In one embedment, login information of a user may be provided by those who set up the database system. A user may then log in to access at least some of their drawings. Some users may have administrative privileges allowing them full access to view and edit the drawings and database, as well as create new users, and the like. Other users may have limited rights such as not being able to edit, create users, and have limited viewing abilities.

Once logged in the users may view a web interface that allows searching, viewing of drawing categories, viewing of site layout, and the like. In a particular embodiment, an interactive interface will allow users to visually click through a site, building and building level to access the desired drawings. For example, a user may click on building 1, and then view the building floors, and may click on a desired floor, to be presented with the different drawings available for that floor. These drawings may then be further sorted based on drawing particulars.

In some embodiments, users may request access by making a submission to the system to request additional drawing information, or access to additional drawings.

The present system greatly streamlines the current drawing storage methods which involve manually going to a room containing hard copies of particular drawings, manually finding the right drawings, and physically manipulating them. This archaic system is replaced with the present invention which allows rapid, remote access to electronic copies of drawings which can be easily found, used, and accessed anywhere.

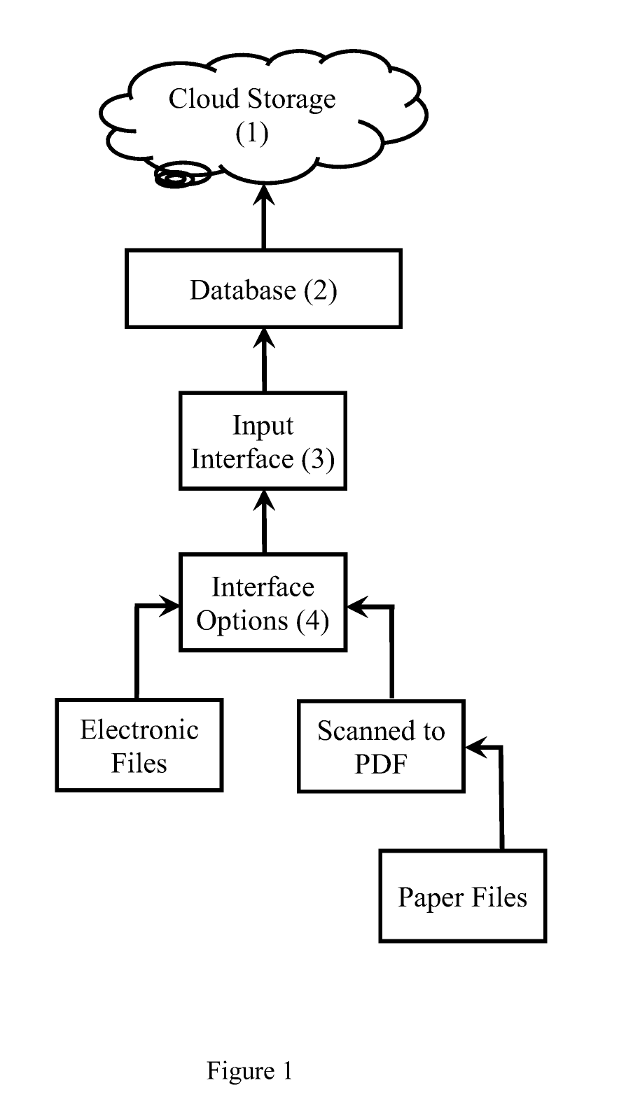

Turning now to FIG. 1 a flow chart of steps involved in an embodiment of system set up is provided. Initially, paper files may be scanned to a portable document format (PDF) or other similar format. These scanned files, along with any existing electronic files may be input to an input interface 3 via an interface option 4. These interface options may include manual input of related information, OCR, iris scanning, optical scanning, audio input, and the like. The input interface may be a spreadsheet or similar file that may easily and effectively organize and categorize information related to an electronic drawing. Once the input interface 3 has been populated with information relating to the scanned and electronic drawings, a database 2 may be populated with the drawings and related information. In one embodiment, a computerized module may be used to analyze the information in the input interface 3 and automatically populate the database 2. In an alternative embodiment, the input interface may be skipped, with the information regarding the drawings being directly input into the database 2. The database 2, once populated, may be accessible to a cloud storage 1, which may be accessible by a networked user such as an internet user, and the like.

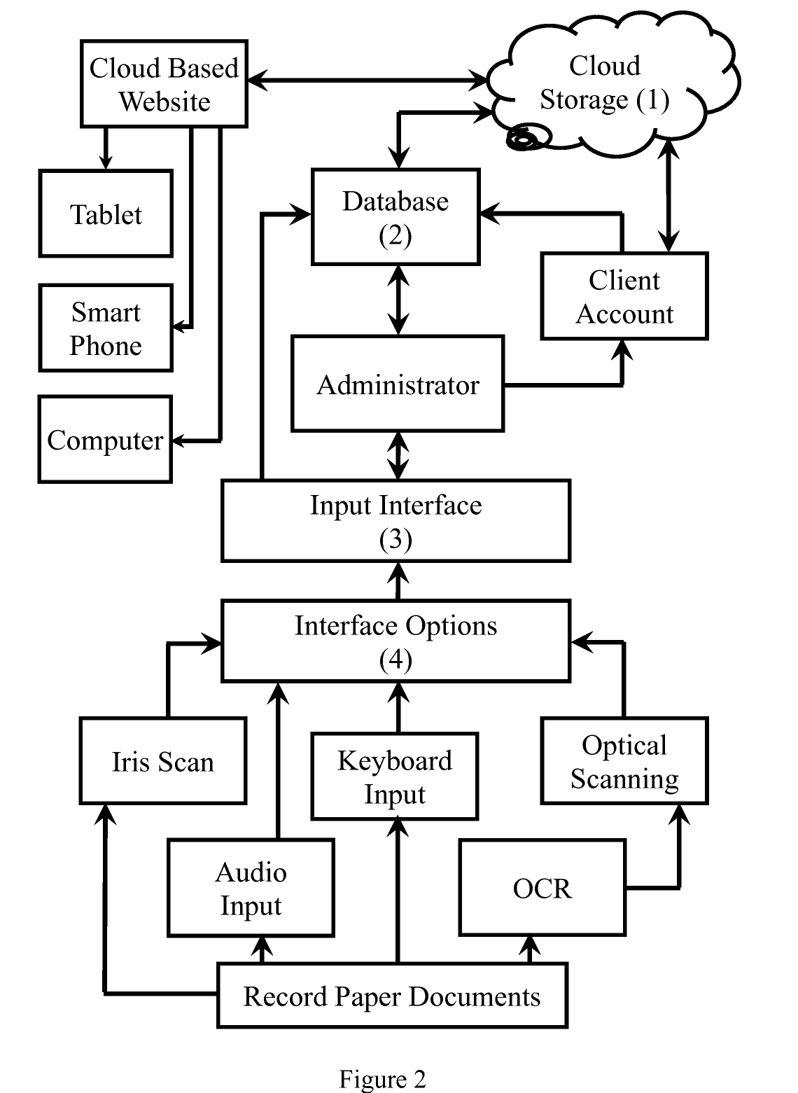

FIG. 2 shows another embodiment of a flow chart of the system in operation. As noted above, scanned paper documents may be recorded and categorized into an input interface 3 using interface options 4 such as an iris scan, audio input, OCR, manual input by keyboard or similar, optical scanning, and the like. The interface input 3 may then be used to populate database 2 along with the scanned or electronic drawings. A system administrator may perform this step, or it may be done automatically using a computerized module, or a combination of the two. An administrator may provide access to a client account to allow the client to access and/or edit the database. Once populated, at least partially, the database may be in communication with a cloud storage system 1. The cloud storage system 1 may in turn be accessible by, in this embodiment, a cloud based website. The cloud based website allows users to access the database using a tablet, smart phone, computer, and the like.

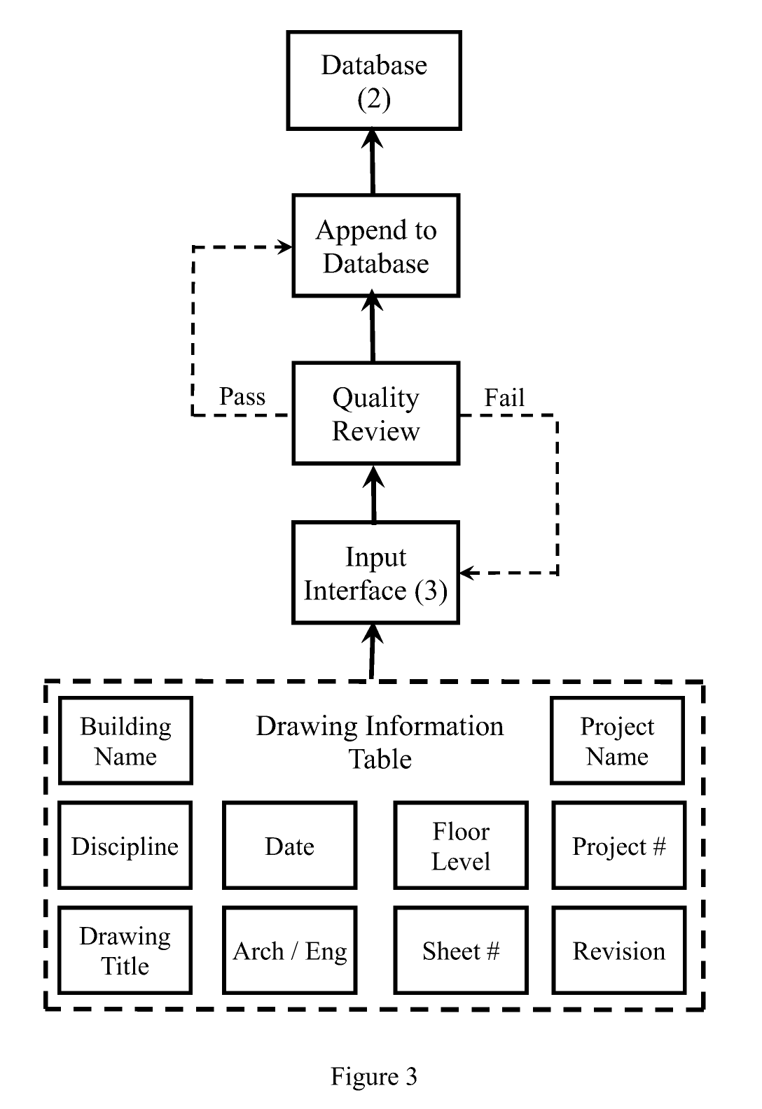

FIG. 3 provides a detail flow chart of populating the database using the computerized module. Drawing information is input in to the input interface 3. This information may include building name, drawing discipline, drawing title, date, drawing type, floor level, sheet number, project name, project number and revision number, among others. The computerized module comprises an error check routine configured to perform a quality review to confirm that the required information is provided to the database. If there is missing information, the error check routine will provided a text or similar output indicating what information is missing. This information may be either manually or automatically filled in. If the error check routine passes certain information, it is then appended to the database by the computerized module, thereby populating the database.

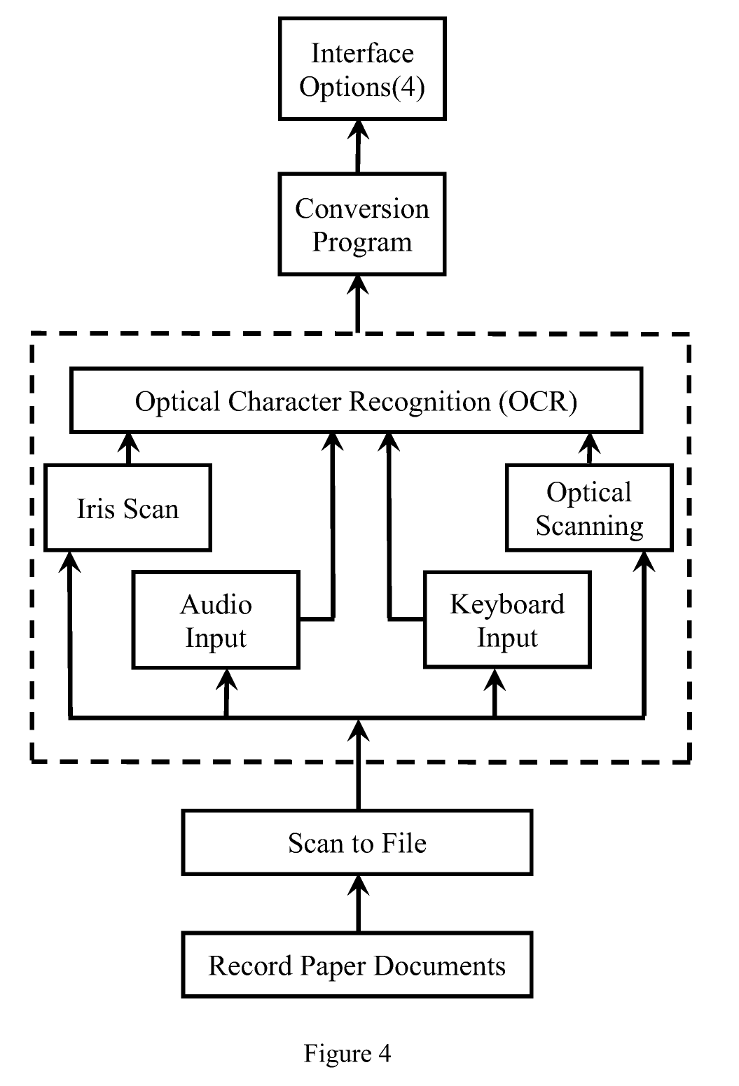

FIG. 4 provides a flow chart of details of interface options for importing paper documents into the system. The chart begins with recorded paper documents which are scanned or otherwise input into an electronic file. This scanning or inputting may occur by a keyboard input, optical scanning, optical character recognition, I.R.I.S. Group® character recognition scanning, and the like. A conversion program may be used to convert the electronic file created into another format, such as into a spreadsheet.

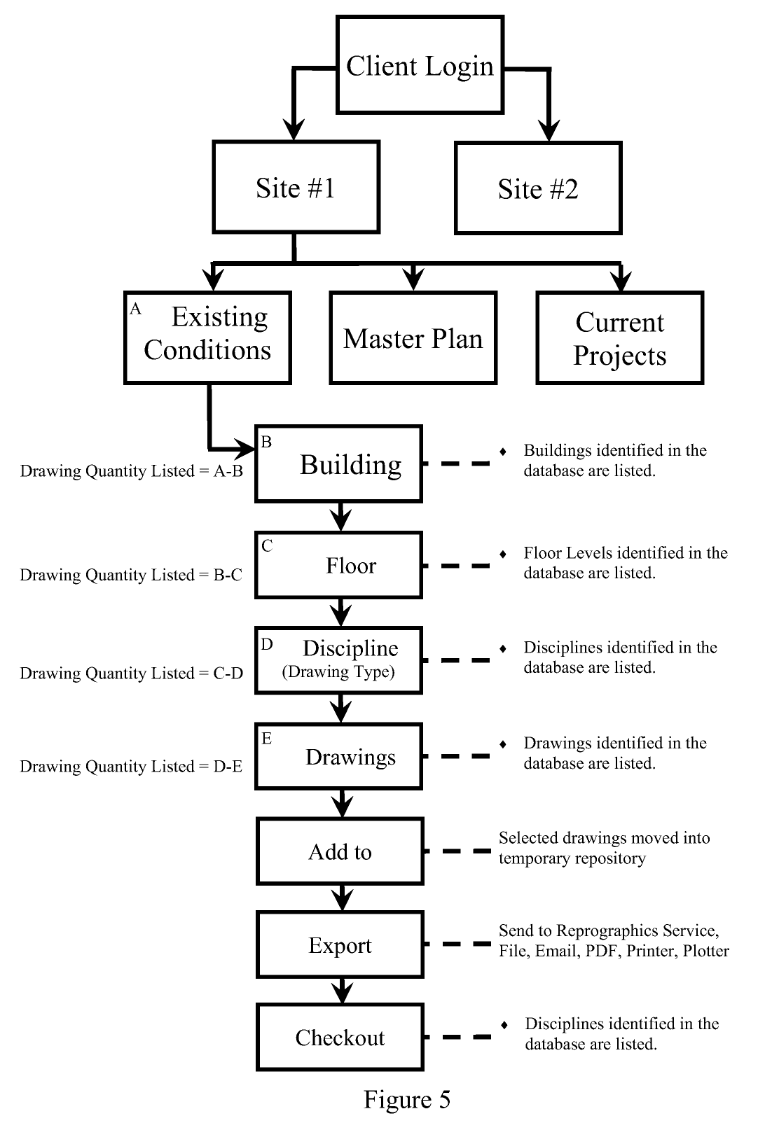

FIG. 5 provides a flow chart of an embodiment of a client side interface provided by the system. Initially, it can be seen that the client is logged in. Once logged in, the client may access documents from any number of sites that they have access to. In this embodiment, the client login provides access to two building sites. Under site #1, the client may access drawings and documents relating to existing conditions, master plan, and current projects. Upon selecting the existing documents, the user may access the documents in an organized manner. Initially, the user may select the building of the site, next. Once the building is selected, the floor options may be shown and one may be selected. Within the selected floor level, a list of drawing types or disciplines is listed. After a user selects drawing discipline, the specific drawings corresponding to building, floor, and discipline may be presented. At this point, the desired drawings may be selected and accessed. In this embodiment, the selected drawings, once identified, may be exported, and checked out. In some embodiments, the system may provide purchase of drawings individually, such that once the drawings are selected, a user may pay for them, and then be provided full access in the form of an electronic file, printable web page, and the like.

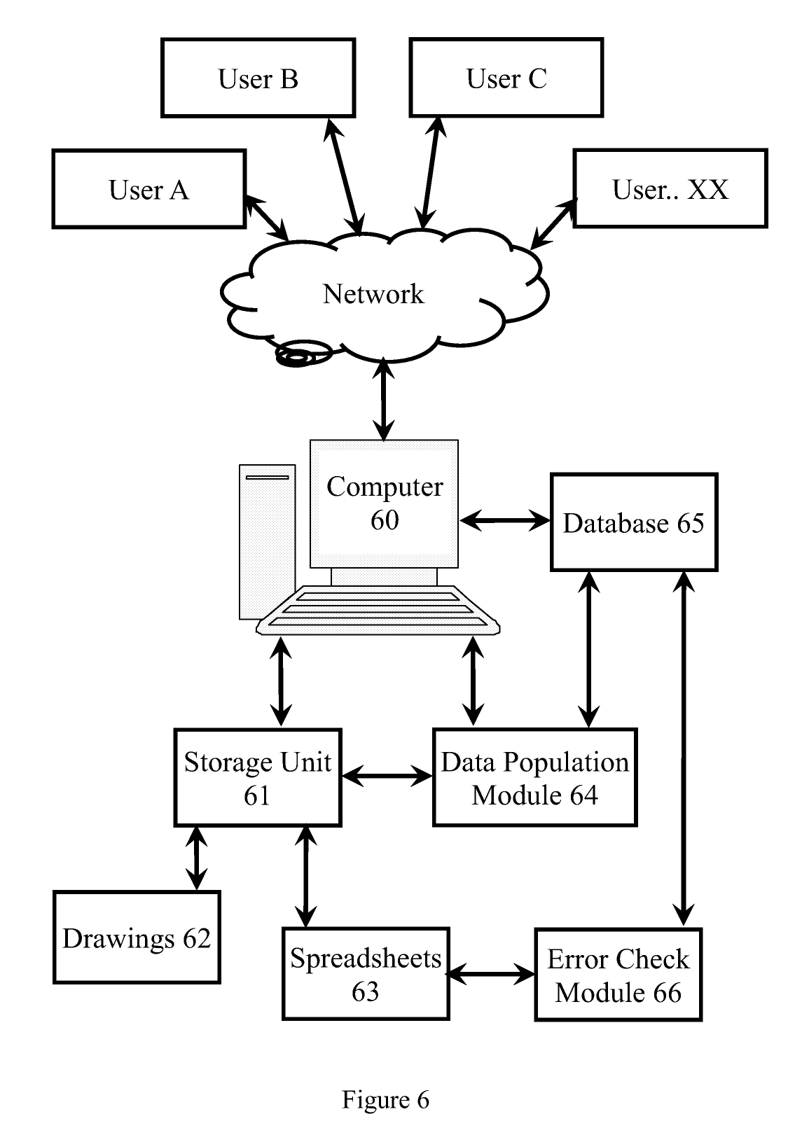

FIG. 6 provides a data flow chart of the components of an embodiment of the system. A computer 60 is shown centrally located. This computer 60 acts as the server on which the system is operated. In one embodiment, the computer 60 may be a single unit, and in other embodiments, the computer may be operated on multiple units or in a cloud based environment. A storage unit 61 is in communication with the computer. The storage unit 61 may be any structure capable of electronic data storage. Examples of storage units include, but are not limited to, optical media, magnetic media, and flash memory based storage, among others. A quantity of drawings 62 in electronic format and a spreadsheet 63 are stored on the storage unit 61. A data population module 64 is in communication with the computer, and also shown optionally in communication directly with the storage unit 61. The data population module 64 may be a process performed by the computer 60 in one embodiment, or a computerized operation performed by a separate computing device in communication with the computer 60. The data population module 64 is configured to automatically populate database 65 with data from the spreadsheet 63, and with the drawings 62. The database 65 may be in communication with the computer 60 directly, or in communication with the data population module 64 directly. An error check module 66 may be in communication with either the database 65, spreadsheet 63, or both. The error check module may be a computerized process that checks for errors in data entries of the spreadsheet 63 or database 65. As with the data population module 64, the error check module 66 may be a process performed by the computer 60, or may be a separate computerized process in communication with the computer 60.

The computer 60 is in communication with a network allowing any number of users to access data of the computer 60. In particular, the database 65 is configured to be accessible to the users through the computer 60. In one embodiment, the computer 60 may present the database and its content in the form of a website.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A method of scanning, organizing, and providing access to building plan drawings comprising the steps of:
identifying building plan drawings;
receiving the identified building plan drawings in scanned electronic format by at least one computer;
inputting information relating to each of the scanned building plan drawings into a computerized spreadsheet of the at least one computer, the inputted information comprising: building name, drawing floor level, and drawing discipline;
populating a database using a computerized database population module, the database population module configured to generate a plurality of database entries based on the inputted information from the spreadsheet, the database population module further configured to associate the inputted information relating to each drawing with the scanned drawing;
repopulating the database using the computerized database population module upon receipt of new or updated building plan drawings;
providing computerized access to the database to an authorized user, the database being organizable based on the inputted information relating to the drawings, all information being accessible to the authorized user.

2. The method of scanning, organizing, and providing access to building plan drawings of claim 1 wherein the step of receiving the identified building plans drawings comprises scanning the identified building plan drawings into at least one computer using a scanner in communication with the at least one computer.

3. The method of scanning, organizing, and providing access to building plan drawings of claim 1 further comprising the step of:
organizing the building drawings firstly based on the building name, secondly based on the floor number, and thirdly based on drawing discipline.

4. The method of scanning, organizing, and providing access to building plan drawings of claim 1 wherein the step of inputting information relating to the scanned building plan drawings comprises the step of using a computerized processing module to automatically input the information relating to the scanned building plan drawings, the computerized processing module configured to use optical character recognition to identify the information relating to the scanned building plan drawing, extract the identified information, and input that information into the spreadsheet.

5. The method of scanning, organizing, and providing access to building plan drawings of claim 1 wherein the step of inputting information relating to the scanned building plan drawings comprises the step of the at least one computer using a computerized guidance module for instructing an operator to identify a region of one of the building plan drawings corresponding to one of the information relating to the building plan drawing; and
filling in a field of the spreadsheet with the identified information using optical character recognition by the computerized guidance module.

6. The method of scanning, organizing, and providing access to building plan drawings of claim 1 further comprising the step of checking for errors and omitted information using a computerized error check module, the error check module identifying missing or improper information input into the spreadsheet and providing an output identifying the missing or improper information.

7. The method of scanning, organizing, and providing access to building plan drawings of claim 1 further comprising the step of checking for errors and omitted information using a computerized error check, the error check module identifying missing or improper information populated into the database and providing an output identifying the missing or improper information.

8. The method of scanning, organizing, and providing access to building plan drawings of claim 1 wherein the inputted information further comprises: drawing title, drawing date, sheet number, project name, project number, and revision number.

9. The method of scanning, organizing, and providing access to building plan drawings of claim 1 further comprising the step of providing a visual output of the building site of which the building site drawings belong by displaying an aerial view of the site.

10. A method of accessing a building drawing of a set of site drawings using a computer comprising the steps of:
logging into a computer accessible building drawing access service by a user, the user using a computer to log in;
identifying a building site having a set of site drawings;
selecting the building site having the set of site drawings;
identifying a building by name of the building site;
selecting the building of the building site
identifying a floor of the identified building from a plurality of floors of the building;
selecting the floor;
identifying a drawing discipline for the selected floor of the selected building;
selecting the drawing discipline for the selected floor of the selected building;
identifying a desired building drawing; and
acquiring the desired building drawing.

11. The method of accessing a building drawing of a set of site drawings using a computer of claim 10 wherein the step of acquiring the desired building drawing comprises the step of purchasing the drawing and printing the drawing.

12. The method of accessing a building drawing of a set of site drawings using a computer of claim 10 further comprising the step of identifying the desired building drawing based on drawing information comprising: drawing title, date, sheet number, project name, project number or revision number.

13. The method of accessing a building drawing of a set of site drawings using a computer of claim 10 further comprising selecting a second desired drawing of a different floor than that of the desired drawing.

14. A system for scanning, organizing, and providing access to building plan drawings comprising:
a computer in communication with an electronic storage unit, the storage unit having a quantity of scanned building plan drawings, and a spreadsheet containing information relating to each building plan drawing;
a computerized data population module in communication with the computer and the storage unit, the data population module configured to automatically populate a database accessible to the computer with contents of the spreadsheet and building plan drawings, the computerized data population module also capable of supplementing the database with additional information provided by a second spreadsheet or an updated spreadsheet;
wherein the database is configured to be remotely accessible to a plurality of computerized users, the computerized users capable of sorting the building plan drawings based on the information related to the building plan drawings, and further capable of accessing and receiving the building plan drawings.

15. The system for scanning, organizing, and providing access to building plan drawings of claim 14 further comprising a scanning system, the scanning system comprising a computerized interface and a scanner device, the scanning system configured to convert paper building plan drawings into the scanned building plan drawings.

16. The system for scanning, organizing, and providing access to building plan drawings of claim 14 further comprising a computerized spreadsheet input module of the computer, the spreadsheet input module configured to extract a quantity of information from the scanned building plan drawings and record it to the spreadsheet.

17. The system for scanning, organizing, and providing access to building plan drawings of claim 16 further comprising a hand scanning device, and wherein the spreadsheet input module is configured to use optical character recognition to interpret a quantity of information relating to the building plan drawings scanned in using the hand scanning device.

18. The system for scanning, organizing, and providing access to building plan drawings of claim 16 wherein the spreadsheet input module is configured to automatically identify particular information relating to each building plan drawing, record this information using optical character recognition, and input the recording information into the spreadsheet.

19. The system for scanning, organizing, and providing access to building plan drawings of claim 15 wherein the information relating to each building plan drawing comprises a building name, building floor, and drawing discipline, and wherein the database is organized by building name, building floor, and drawing discipline.

20. The system for scanning, organizing, and providing access to building plan drawings of claim 13 wherein the computer further comprising an error tracking module in electronic communication with the storage unit, the error tracking module configured to identify missing or improper information populated into the spreadsheet, and configured to provide an output identifying the missing or improper information.
